(19) United States
(12) Patent Application Publication
(10) Pub. No.: US 2024/0277568 A1
(43) Pub. Date: Aug. 22, 2024

(54) Sauna room for home

(71) Applicant: DUCOBA CO.,LTD, Gwangju-si (KR)

(72) Inventor: Kyung Kook Yang, Namyangju-si (KR)

(21) Appl. No.: 18/444,979

(22) Filed: Feb. 19, 2024

(30) Foreign Application Priority Data
Feb. 20, 2023 (KR) 10-2023-0022257

(51) Int. Cl. A61H 33/06

(52) U.S. Cl. CPC A61H 33/066; A61H 33/063; A61H 2033/061; A61H 2201/0207; A61H 2201/0242

(57) ABSTRACT

A sauna room for home according to an aspect of the present disclosure may include a floor plate with a heating unit installed, a plurality of walls built on the floor plate, and an upper plate installed on an upper portion of the walls, wherein the wall may include a hollow panel with an insulating space formed therein, and the hollow panel may include a first support plate and a second support plate spaced apart to face each other, and a support rib disposed between the first support plate and the second support plate and connecting the first support plate and the second support plate.

### CROSS REFERENCE TO RELATED APPLICATION

The present application claims priority to Korean Patent Application No. 10-2023-0022257, filed on Feb. 20, 2023, the entire contents of which are incorporated herein for all purposes by this reference.

### BACKGROUND OF THE INVENTION

### 1. Field of the Invention

The present disclosure relates to a sauna room, and more specifically, to a sauna room for home installed in a home.

### 2. Description of the Background Art

Home sauna booths, which have been in the spotlight recently, are generally wooden booths using cypress wood as a finishing material. In other words, cypress wood, which has a good scent and may be used as a raw wood without varnish or painting, also contains phytoncide and has been widely used as bathroom wood from old times. Accordingly, cypress wood is also being used in home sauna booths.

In the recent real estate market of luxury villas and luxury apartments, kitchens made of sophisticated materials and built-in home appliances are provided as options, and even relatively expensive home sauna booths are being introduced as options.

However, conventional wooden sauna rooms such as cypress wood have issues with low heat transfer efficiency and excessively high manufacturing costs. In addition, this sauna room is made of a material that easily combusts in the event of a fire, so it is very vulnerable to fire.

### SUMMARY OF THE INVENTION

An aspect of the present disclosure provides a sauna room for home that is easy to install and has an improved thermal insulation effect. In addition, an aspect of the present disclosure provides a sauna room for home that reduces manufacturing costs and is light in weight.

The sauna room for home according to an aspect of the present disclosure may include a floor plate with a heating unit installed, a plurality of walls built on the floor plate, and an upper plate installed on an upper portion of the walls, wherein the wall may include a hollow panel with an insulating space formed therein, and the hollow panel may include a first support plate and a second support plate spaced apart to face each other, and a support rib disposed between the first support plate and the second support plate and connecting the first support plate and the second support plate.

The hollow panel according to an aspect of the present disclosure may be made of a polycarbonate panel.

The hollow panel according to an aspect of the present disclosure may be formed with a plurality of scratch grooves extending in a height direction of the wall.

The wall according to an aspect of the present disclosure further includes a heating element, wherein the heating element may include a base plate with grooves formed, and a hot water tube inserted into the base plate and having a space within which fluid moves.

The heating element according to an aspect of the present disclosure further includes a heat diffusion member that diffuses heat of the hot water tube, wherein the heat diffusion member may include a heat absorbing unit that is inserted into the groove and surrounds the hot water tube, and a diffusion unit that protrudes laterally from the heat absorbing unit and contacts the base plate.

The base plate according to an aspect of the present disclosure may be made of a panel formed by compressing stone and polyvinyl chloride resin (PVC).

The wall according to an aspect of the present disclosure may include cork, and may further include an inner cork panel disposed inside the hollow panel.

The hollow panel according to an aspect of the present disclosure may be located between the first support plate and the second support plate, and further include an intermediate plate parallel to the first support plate and the second support plate and an inclined rib extending in an inclined direction with respect to the intermediate plate, wherein the support rib may be disposed perpendicular to the intermediate plate.

The wall according to an aspect of the present disclosure may further include an outer cork panel disposed outside the hollow panel and including cork, and an inner cork layer disposed inside the heating element and including cork.

The inner cork layer according to an aspect of the present disclosure may be formed by coating a material containing cork, water-soluble resin, and diatomaceous earth by spraying.

As described above, according to an embodiment of the present disclosure, a wall includes a hollow panel with an insulating space formed therein, and the hollow panel includes a first support plate, a second support plate, and a support rib, thereby improving thermal efficiency and reducing manufacturing costs.

In addition, scratch grooves are formed in the hollow panel to prevent the hollow panel with low hardness from becoming dirty due to scratches, etc.

In addition, since a heating element is installed on the wall and the heating element includes a heat diffusion member, heat can be easily transferred to the inside of a sauna room. Additionally, a base plate is formed by compressing stone and polyvinyl chloride resin (PVC), and thus has excellent thermal conductivity and can further improve thermal efficiency.

In addition, the wall includes cork panels, and thus not only has improved insulation performance, but can also provide the same texture as wood while ensuring flame retardancy.

### BRIEF DESCRIPTION OF THE DRAWINGS

FIG. 1 is a perspective view of a sauna room for home according to a first embodiment of the present disclosure.

FIG. 2 is a cross-sectional view of a wall according to the first embodiment of the present disclosure.

FIG. 3 is a cross-sectional view of a wall according to a second embodiment of the present disclosure.

FIG. 4 is a perspective view of a heating element according to a second embodiment of the present disclosure.

FIG. 5 is a cross-sectional view of a heating element according to a second embodiment of the present disclosure.

FIG. 6 is a perspective view of a wall according to a third embodiment of the present disclosure.

FIG. 7 is a cross-sectional view of a wall according to a fourth embodiment of the present disclosure.

### DETAILED DESCRIPTION OF THE INVENTION

The present disclosure may be variously modified and may include various embodiments. Specific embodiments will be exemplarily illustrated in the drawings and described in detail in the detailed description of the embodiments. However, it should be understood that they are not intended to limit the present disclosure to specific embodiments but rather to cover all modifications, equivalents, and alternatives which are included in the spirit and scope of the present disclosure.

The terms used herein are presented for the description of the specific embodiments but are not intended to limit the present disclosure. The terms in singular form may include plural forms unless otherwise specified. It will be understood that the terms “comprising” or “having,” when used herein, specify the presence of stated features, integers, steps, operations, elements, components, or combinations thereof, but do not preclude the presence or addition of one or more other features, integers, steps, operations, elements, components, and/or combinations thereof.

Hereinafter, preferred embodiments of the present disclosure will be described in detail with reference to the accompanying drawings. In this connection, it should be noted that the same reference numerals are used throughout the accompanying drawings to designate the same components. A detailed description of the known function and configuration which may make the gist of the present disclosure obscure will be omitted. Likewise, in the accompanying drawings, some components may be exaggerated, omitted or schematically illustrated.

Hereinafter, a sauna room for home according to an embodiment of the present disclosure will be described.

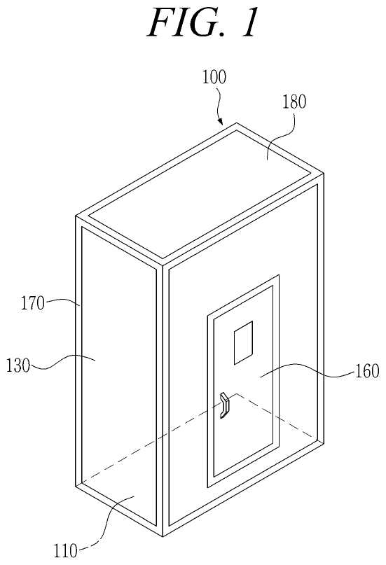

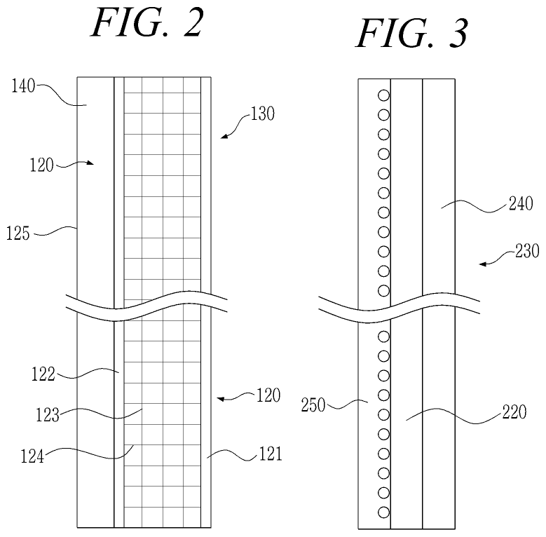

FIG. 1 is a perspective view of a sauna room for home according to a first embodiment of the present disclosure. FIG. 2 is a cross-sectional view of a wall according to the first embodiment of the present disclosure.

Referring to FIGS. 1 and 2, a sauna room 100 for home use according to this embodiment may be installed in a veranda, living room, master bedroom, etc. of households, or may be a portable sauna room that may be installed in a gym, school, etc. Additionally, a sauna room for home is a concept that includes a sauna for home use and is a device that heats an inner space using an inner space and a heating element.

The sauna room 100 for home use may include a floor plate 110, an upper plate 180, a wall 130, and a door 160, and may have a substantially rectangular parallelepiped shape. Chairs, far-infrared lamps, steam generators, etc. may be installed inside the sauna room 100 for home use.

The floor plate 110 may be made in the shape of a square plate, and a heating unit for heating the floor plate 110 may be installed on the floor plate 110. Herein, the heating unit may be made of a hot water tube, and hot water heated by a gas boiler or electric boiler may be supplied to the hot water tube. Additionally, the heating unit may be made of a heating wire or the like that generates heat by electricity.

The upper plate 180 is coupled to an upper portion of the wall 130 and seals an upper end of the sauna room 100 for home use. The upper plate 180 and the floor plate 110 may include hollow panels made of polycarbonate.

The wall 130 connects the floor plate 110 and the upper plate 180, and may be disclosed to stand against the floor plate 110. The sauna room 100 for home use according to this embodiment may include four walls 130, but an embodiment of the present disclosure is not limited thereto.

The sauna room 100 for home use may include a plurality of frames 170, and the wall 130, the floor plate 110, and the upper plate 180 may be fixed to the frame 170. The frame 170 may be made of metal or synthetic resin and may be coupled in a prefabricated manner.

The wall 130 may include a hollow panel 120 with an insulating space formed therein and an inner cork panel 140 disposed inside the hollow panel 120.

The hollow panel 120 may include a first support plate 121, a second support plate 122, an intermediate plate 123, and a support rib 124. The hollow panel 120 may have an insulating space formed therein, and the insulating space may be divided in a width direction of the wall 130 and extend in a height direction of the wall 130. The first support plate 121 and the second support plate 122 are spaced apart from each other and are disposed to face each other. The intermediate plate 123 may be installed between the first support plate 121 and the second support plate 122, and the intermediate plate 123 may be disposed parallel to the first support plate 121 and the second support plate 122. However, an embodiment of the present disclosure is not limited thereto, and the intermediate plate may be omitted.

The support ribs 124 may be disposed perpendicularly to the first support plate 121, the second support plate 122, and the intermediate plate 123 and connect the same, and a plurality of the support ribs 124 may be spaced apart from each other at intervals. The hollow panel 120 may be made of polycarbonate or a translucent material.

The inner cork panel 140 includes cork and is disposed inside the hollow panel 120. The inner cork panel 140 may be made of oak cork, etc., or may be made of a compression molded plate. As is known, cork may be made of oak bark. However, an embodiment of the present disclosure is not limited thereto, and cork may be made of the bark of various trees. The inner cork panel 140 is waterproof and insulating and may have a fire retardant effect.

In addition, a door 160 is installed on one of the walls 130. The door 160 may be rotatably installed on the wall 130 or may be installed in a sliding shape. The door 160 may include a hollow panel made of polycarbonate and a cork panel attached to the hollow panel.

Accordingly, the wall 130 according to this embodiment includes the hollow panel 120 and the inner cork panel 140, and thus not only blocks heat inside the sauna room 100 for home use from being emitted to the outside, but also secures waterproofing performance. Additionally, manufacturing costs may be significantly reduced compared to the past.

Hereinafter, a wall according to a second embodiment of the present disclosure will be described.

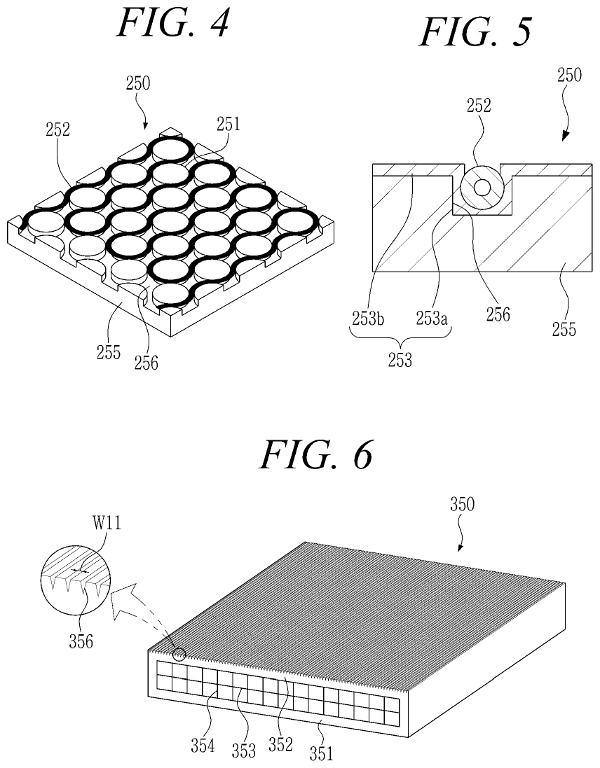

FIG. 3 is a cross-sectional view of a wall according to a second embodiment of the present disclosure. FIG. 4 is a perspective view of a heating element according to a second embodiment of the present disclosure. FIG. 5 is a cross-sectional view of a heating element according to a second embodiment of the present disclosure.

Referring to FIGS. 3 to 5, the wall 230 according to this embodiment may include a hollow panel 220 with an insulating space formed therein, a heating element 250 disposed inside the hollow panel 220, and an outer cork panel 240 disposed outside the hollow panel 220.

The hollow panel 220 may have an insulating space formed therein, and the insulating space may be formed along a height direction of the wall 230. The hollow panel 220 may be made of polycarbonate or a translucent material.

The heating element 250 may have a plate shape and may include a base plate 255, a hot water tube 252, and a heat diffusion member 253. A groove 256 into which the hot water tube 252 is inserted is formed in the base plate 255, and the groove 256 may be located between circular protrusions 251.

The base plate 255 may be made of a panel formed by compressing stone and polyvinyl chloride resin (PVC), provide a texture similar to stone, and be made of a material with excellent thermal conductivity. Accordingly, the heat conductivity of the base plate 255 is excellent and heat may quickly spread throughout the wall.

The hot water tube 252 may have a space within which fluid moves, and hot water may be heated by a boiler or electric heater and supplied to the hot water tube 252. The hot water tube 252 may be bent while partially surrounding the circular protrusions and lead to a zigzag pattern.

The heat diffusion member 253 transfers the heat of the hot water tube 252 to the base plate 255 and spreads the heat. The heat diffusion member 253 may be made of aluminum or copper, and may include a heat absorbing unit 253a that is inserted into the groove 256 and surrounds the hot water tube 252, and a diffusion unit 253b that protrudes laterally from the heat absorbing unit 253a and contacts the base plate 255.

The heat absorbing unit 253a may be inserted into the groove 256, and a thermally conductive adhesive layer may be formed between the heat absorbing unit 253a and the hot water tube 252. The diffusion unit 253b is made of a plate that protrudes laterally from the heat absorbing unit 253a and is located outside the groove 256. The diffusion unit 253b diffuses the heat transferred from the heat absorbing unit 253a and transfers the same to the base plate 255.

As described above, according to this embodiment, the heat transferred from the hot water tube 252 may be quickly and easily spread throughout the wall 230 by the heat diffusion member 253 and the base plate 255.

The outer cork panel 240 includes cork and is disposed outside the hollow panel 220. The outer cork panel 240 may be made of oak cork, etc., or may be made of a compression molded plate or sheet.

As described above, since the wall 230 according to this embodiment includes the heating element 250, heat may be generated not only from the floor but also from the wall 230 and quickly transferred to the internal space. In addition, since the heating element 250 includes the base plate 255 and the heat diffusion member 253, heat may be spread quickly, and the insulation effect may be improved by installing the outer cork panel 240.

Hereinafter, a wall according to a third embodiment of the present disclosure will be described.

FIG. 6 is a perspective view of a wall according to a third embodiment of the present disclosure.

Referring to FIG. 6, the wall according to this embodiment may include a hollow panel 350 with an insulating space formed therein.

The hollow panel 350 may have an insulating space formed inside, and the insulating space may be formed along a height direction of the wall. The hollow panel 350 may be made of polycarbonate or a translucent material.

The hollow panel 350 may include a first support plate 351, a second support plate 352, an intermediate plate 353, and a support rib 354. The first support plate 351 and the second support plate 352 are spaced apart from each other and are disposed to face each other. At least one intermediate plate 353 may be installed between the first support plate 351 and the second support plate 352, and the intermediate plate 353 may be disposed parallel to the first support plate 351 and the second support plate 352. The support rib 354 may be disposed perpendicularly to the first support plate 351, the second support plate 352, and the intermediate plate 353 and connect the same, and a plurality of the support ribs 354 may be spaced apart from each other at intervals.

In addition, a plurality of scratch grooves 356 extending in a height direction of the wall may be formed in the second support plate 352 disposed on the outside. The scratch groove 356 may have a triangular cross-section and may be formed during an extrusion process.

The maximum width W11 of the scratch groove 356 may be 1/100 mm to 1/10 mm. The hollow panel 350 made of polycarbonate has excellent physical strength, but has low Vickers hardness. Accordingly, the hollow panel 350 is vulnerable to scratches, and the durability of the outer surface is weak. However, when the scratch groove 356 is formed in advance, external damage due to scratches may be minimized and surface strength may be improved.

Hereinafter, a wall according to a fourth embodiment of the present disclosure will be described.

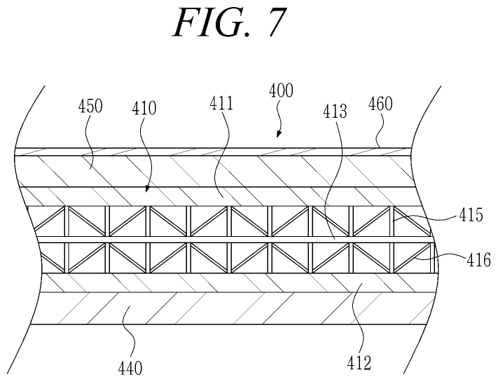

FIG. 7 is a cross-sectional view of a wall according to a fourth embodiment of the present disclosure.

Referring to FIG. 7, a wall 400 according to this embodiment may include a hollow panel 410 with an insulating space formed therein, a heating element 450 disposed inside the hollow panel 410, an outer cork panel 410 disposed outside the hollow panel 410, and an inner cork layer 460 disposed inside the heating element 450.

The hollow panel 410 has an insulating space formed inside, and the insulating space may be formed along a height direction of the wall. The hollow panel 410 may be made of polycarbonate or a translucent material.

The hollow panel 410 may include a first support plate 411, a second support plate 412, an intermediate plate 413, a support rib 415, and an inclined rib 416. The first support plate 411 and the second support plate 412 are spaced apart from each other and are disposed to face each other. The intermediate plate 413 may be installed between the first support plate 411 and the second support plate 412. The support rib 415 is disposed perpendicularly to the first support plate 411, the second support plate 412, and the intermediate plate 413 and connects the same. The inclined rib 416 may extend in an inclined direction with respect to the intermediate plate 413 and may be connected to the support rib 415.

The heating element 450 is formed in a plate shape and includes a hot water tube so that the wall 400 generates heat. Hot water may be heated by a boiler or electric heater and supplied to the hot water tube.

The outer cork panel 440 includes cork and is disposed outside the hollow panel 410. The outer cork panel 440 may be made of oak cork, etc., or may be made of a compression molded plate or sheet.

The inner cork layer 460 may have a smaller thickness than the outer cork panel 440 and may be formed by spray coating a material containing cork, water-soluble resin, and diatomaceous earth. The inner cork layer 460 may provide the texture of wood while preventing burns to a user. In addition, the inner cork layer 460 may be formed with a thin thickness to minimize heat blocking.

In addition, when the outer cork panel 440 and the inner cork layer 460 are formed, scratches on the hollow panel 410 may be prevented.

Hereinbefore, an embodiment of the present disclosure has been described. However, it will be apparent to those skilled in the pertinent technical field that various changes and modifications may be made without departing from the idea of the present disclosure as described in the claims by adding, modifying, and deleting the constituents and that such changes and modifications are within the scope of right of the present disclosure.

1. A sauna room for home, the sauna room comprising:
a floor plate with a heating unit installed;
a plurality of walls built on the floor plate; and
an upper plate installed on an upper portion of the walls,
wherein the wall comprises a hollow panel with an insulating space formed therein, and
the hollow panel comprises a first support plate and a second support plate spaced apart to face each other, and a support rib disposed between the first support plate and the second support plate and connecting the first support plate and the second support plate.

2. The sauna room of claim 1, wherein the hollow panel is made of a polycarbonate panel.

3. The sauna room of claim 2, wherein the hollow panel is formed with a plurality of scratch grooves extending in a height direction of the wall.

4. The sauna room of claim 2, wherein the wall further comprises a heating element, and the heating element comprises a base plate with grooves formed, and a hot water tube inserted into the base plate and having a space within which fluid moves.

5. The sauna room of claim 4, wherein the heating element further comprises a heat diffusion member that diffuses heat of the hot water tube, and the heat diffusion member comprises a heat absorbing unit that is inserted into the groove and surrounds the hot water tube, and a diffusion unit that protrudes laterally from the heat absorbing unit and contacts the base plate.

6. The sauna room of claim 5, wherein the base plate is made of a panel formed by compressing stone and polyvinyl chloride resin (PVC).

7. The sauna room of claim 2, wherein the wall comprises cork, and further comprises an inner cork panel disposed inside the hollow panel.

8. The sauna room of claim 4, wherein the hollow panel is located between the first support plate and the second support plate, and further comprises an intermediate plate parallel to the first support plate and the second support plate and an inclined rib extending in an inclined direction with respect to the intermediate plate, wherein the support rib is disposed perpendicular to the intermediate plate.

9. The sauna room of claim 8, wherein the wall further comprises an outer cork panel disposed outside the hollow panel and comprising cork, and an inner cork layer disposed inside the heating element and comprising cork.

10. The sauna room of claim 9, wherein the inner cork layer is formed by coating a material containing cork, water-soluble resin, and diatomaceous earth by spraying.
